(19) United States
(12) Patent Application Publication
(10) Pub. No.: US 2023/0254866 A1
(43) Pub. Date: Aug. 10, 2023

(54) METHODS, DEVICES, AND MEDIUM FOR COMMUNICATION

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/015,895

(22) PCT Filed: Jul. 14, 2020
(86) PCT No.: PCT/CN2020/101972

§ 371 Date: Jan. 12, 2023

(51) Int. Cl. H04W 72/21

(52) U.S. Cl. CPC H04W 72/21

(57) ABSTRACT

Embodiments of the present disclosure relate to methods, devices, and medium for communication. A method of communication comprises determining, at a terminal device served by a first network device, that uplink transmission is to be performed with a second network device serving the terminal device. The method further comprises transmitting, to the first network device, a request to activate a cell group of the second network device, the request comprising characteristic information concerning the uplink transmission.

### TECHNICAL FIELD

Embodiments of the present disclosure generally relate to the field of telecommunication, and in particular, to methods, devices, and medium for communication.

### BACKGROUND

Dual Connectivity is a mode of operation where a terminal device (for example, user equipment, UE) can be configured to utilize radio resources provided by two network devices (for example, two base stations). A first network device serves the terminal device as a Master Node (MN), and a second network device serves the terminal device as a Secondary Node (SN). The MN and SN are connected via a non-ideal back-haul over a network interface and at least the MN is connected to a core network (CN).

The MN and SN may be associated with one or more serving cells. In a carrier aggregation (CA) scenario, each of the MN and SN may be associated with a group of serving cells including a primary cell (PCell) and optionally one or more secondary cells (SCells). The group of serving cells associated with the MN is referred to as a Master Cell Group (MCG) and the group of serving cells associated with the SN is referred to as a Secondary Cell Group (SCG). In some cases, the SCG may be suspended to reduce power consumption for example. The suspended SCG may need to be resumed due to uplink data arrival. However, mechanism of SCG resumption has not be specified.

### SUMMARY

In general, example embodiments of the present disclosure provide a solution for SCG resumption.

In a first aspect, there is provided a method of communication. The method comprises determining, at a terminal device served by a first network device, that uplink transmission is to be performed with a second network device serving the terminal device; and transmitting, to the first network device, a request to activate a cell group of the second network device, the request comprising characteristic information concerning the uplink transmission.

In a second aspect, there is provided a method of communication. The method comprises receiving, at a first network device from a terminal device, a request to activate a cell group of a second network device, the terminal device served by the first network device and the second network device; determining, from the request, characteristic information concerning uplink transmission to be performed with the second network device; and causing the uplink transmission to be performed based on the characteristic information.

In a third aspect, there is provided a method of communication. The method comprises determining, at a terminal device served by a first network device, that uplink transmission is to be performed with a second network device serving the terminal device; enabling transmission on a primary cell of a cell group of the second network device; transmitting, to the second network device on the primary cell, a first request to activate the cell group of the second network device; and monitoring a response to the first request based on a first timer for activation of the cell group.

In a fourth aspect, there is provided a terminal device. The network device includes a processing unit; and a memory coupled to the processing unit and storing instructions thereon, the instructions, when executed by the processing unit, causing the device to perform the method according to the first aspect.

In a fifth aspect, there is provided a network device. The network device includes a processing unit; and a memory coupled to the processing unit and storing instructions thereon, the instructions, when executed by the processing unit, causing the device to perform the method according to the second aspect.

In a sixth aspect, there is provided a terminal device. The terminal device includes a processing unit; and a memory coupled to the processing unit and storing instructions thereon, the instructions, when executed by the processing unit, causing the device to perform the method according to the third aspect.

In a seventh aspect, there is provided a computer readable medium having instructions stored thereon, the instructions, when executed on at least one processor, causing the at least one processor to carry out the method according to the first aspect.

In an eighth aspect, there is provided a computer readable medium having instructions stored thereon, the instructions, when executed on at least one processor, causing the at least one processor to carry out the method according to the second aspect.

In a ninth aspect, there is provided a computer readable medium having instructions stored thereon, the instructions, when executed on at least one processor, causing the at least one processor to carry out the method according to the third aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a block diagram of a communication environment in which embodiments of the present disclosure can be implemented;

FIG. 2 is a signaling chart illustrating process of requesting to the MN for SCG resumption according to some embodiments of the present disclosure;

FIG. 3 is a signaling chart illustrating process of requesting to the SN for SCG resumption according to some embodiments of the present disclosure;

FIG. 4 is a signaling chart illustrating process of requesting to the SN for SCG resumption according to some embodiments of the present disclosure;

FIG. 5 illustrates an example method of communication implemented at a terminal device in accordance with some embodiments of the present disclosure;

FIG. 6 illustrates an example method of communication implemented at a network device in accordance with some embodiments of the present disclosure;

FIG. 7 illustrates an example method of communication implemented at a terminal device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices or evolved MTC (eMTC) DEVICES, devices on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Example Environment

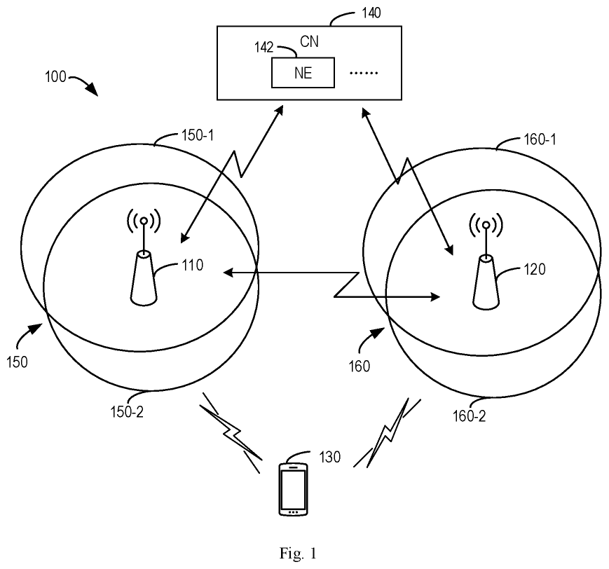

FIG. 1 shows an example communication environment 100 in which example embodiments of the present disclosure can be implemented. In the example of FIG. 1, a plurality of network devices 110, 120 are deployed to serve a terminal device 130. The network device 110 serves the terminal device 130 as the MN, while the network device 120 serves the terminal device 130 as the SN.

The serving areas of the network devices 110, 120 are called as cells. As shown in FIG. 1, a group of cells of the network device 110 includes a primary cell 150-1 and a secondary cell 150-2. Since the network device 110 serves as the MN, the group of cells of the network device 110 is referred to as MCG 150 and the primary cell 150-1 is also referred to as PCell 150-1.

A group of cells of the network device 120 includes a primary cell 160-1 and a secondary cell 160-2. Since the network device 120 serves as the SN, the group of cells of the network device 120 is referred to as SCG 160 and the primary cell 160-1 is also referred to as PSCell 160-1. The PCell 150-1 and PSCell 160-1 may be collectively referred to as SpCell.

It is to be understood that the number of SCells in FIG. 1 is given for the purpose of illustration without suggesting any limitations to the present disclosure. The network devices 110, 120 may provide any suitable number of SCells for serving the terminal device 130.

Communications between the terminal device 130 and the network devices 110, 120 may be implemented according to any proper communication protocol(s). Communication in a direction from a terminal device 130 towards the network device 110 or 120 is referred to as UL communication, while communication in a reverse direction from the network device 110 or 120 towards the terminal device 130 is referred to as DL communication. The terminal device 130 can move amongst the coverage areas of the network devices 110, 120 and possibly other network devices.

In UL communication, the terminal device 130 may transmit UL data and radio resource control (RRC) signaling to the network device 110 or 120 via a UL channel. In some examples, the UL data may be transmitted in a physical uplink shared channel (PUSCH) and/or any other UL channels that are available used for data transmission. In some examples, the RRC signaling may be transmitted in a physical uplink shared channel (PUSCH). In DL transmission, the network device 110 or 120 may transmit DL data and RRC signaling to the terminal device 130 via a DL channel. In some examples, the DL data may be transmitted in a physical downlink shared channel (PDSCH) and/or any other DL channels that are available used for data transmission. In some examples, the RRC signaling may be transmitted in a physical downlink shared channel (PDSCH).

The DC provided by the network devices 110, 120 may comprise any suitable type of Multi-Radio Dual Connectivity (MR-DC), including but not limited to E-UTRA (Evolved Universal Terrestrial Radio Access)-NR Dual Connectivity (EN-DC), NGEN-DC and NR-DC. In the case of EN-DC, the network device 110 is an eNB and the network device 120 is a gNB, for example, enhanced-gNB (en-gNB). In the case of NGEN-DC, the network device 110 is a ng-eNB and the network device 120 is a gNB. In the case of NR-DC, the network devices 110 and 120 are both gNBs.

At least the network device 110 is connected to a CN 140. The CN 140 may comprise functional elements and/or network functions (which may be collectively referred to as network elements, NEs) to support a variety of functions. Specifically, the network device 110 may be connected a NE 142, which may depend on network types. In the case of EN-DC, the NE 142 may include a Mobility Management Entity (MME). The network device 110 may communicate with the MME via S1 interface and the network devices 110 and 120 may communicate with each other via X2 interface for a control plane. In the cases of NGEN-DC and NR-DC, the NE 142 may include an access and mobility management function (AMF). The network device 110 may communicate with the AMF via NG interface and the network devices 110 and 120 may communicate with each other via Xn interface for the control plane. Although not shown, the CN 140 may comprise one or more other functional elements and/or network functions such as a session management function (SMF), a policy control function (PCF), a network exposure function (NEF), and/or the like. The scope of the embodiments of the present disclosure is not limited in this regard.

It is to be understood that the number and type of devices in FIG. 1 are given for the purpose of illustration without suggesting any limitations to the present disclosure. The communication environment 100 may include any suitable number of network devices and/or terminal devices adapted for implementing implementations of the present disclosure. Further, the communication environment 100 may include any other devices than the network devices and the terminal devices, such as a core network element, but they are omitted here so as to avoid obscuring the present invention.

In a communication environment, power consumption of a terminal device (e.g., a UE) and/or a network device (e.g., an eNB, a gNB) is a big issue. Existing power saving solutions for CA scenario comprise SCell activation and deactivation. To enable reasonable power consumption (for example, battery consumption) of UE when CA is configured, an activation/deactivation mechanism of SCells is supported. When an SCell is deactivated, the UE does not need to receive the corresponding PDCCH or PDSCH, cannot transmit in the corresponding uplink, nor is it required to perform Channel Quality Indicator (CQI) measurements. Conversely, when an SCell is activated, the UE shall receive PDSCH and PDCCH (if the UE is configured to monitor PDCCH from this SCell) and is expected to be able to perform CQI measurements.

Existing power saving solutions for CA scenario further comprise Scell Dormancy. To enable fast SCell activation when CA is configured, one dormant bandwidth part (BWP) can be configured for an SCell. If the active BWP of the activated SCell is a dormant BWP, the UE stops monitoring PDCCH on the SCell but continues performing channel state information (CSI) measurements, automatic gain control (AGC) and beam management, if configured. Downlink control information (DCI) is used to control entering/leaving the dormant BWP for one or more SCell(s) or one or more SCell group(s). The dormant BWP is one of the UE's dedicated BWPs configured by network via dedicated RRC signaling. The SpCell and PUCCH SCell cannot be configured with a dormant BWP.

Power saving solution is also needed for DC scenario. As mentioned above, SCG suspension is needed in some cases. Take the EN-DC as an example. Power consumption of the UE and the network is a big issue, due to maintaining two radio links simultaneously. For example, in some cases, power consumption of the UE in NR network is 3 to 4 times higher than that of the UE in the LTE network. In EN-DC deployment, the MN provides the basic coverage. When data rate requirement of the UE changes dynamically, e.g. from high to low, the SN is worth considering to be deactivated or suspended to reduce power consumption. Therefore, an efficient SCG deactivation mechanism should be specified. This efficient SCG deactivation mechanism can also be applied to other MR-DC deployments, including but not limited to NGEN-DC, NR-DC. The terms “SCG suspension” and “SCG deactivation” are used interchangeably herein.

Three options regarding modeling of the SCG suspension have been proposed. In Option 1, all serving cells associated with the SN including PScell and SCells are activated and the active BWP is configured as a dormant BWP. In Option 2, all serving cells associated with the SN including PScell and SCells are deactivated. In Option 3, the SCells of the SCG should be deactivated, while the PScell of the SCG should be activated and the active BWP is configured as a dormant BWP.

As can be seen from the above, different from SCell activation/deactivation and SCell dormancy (where PSCell can maintain data transmission, thus no high layer handling), in the SCG suspension, neither PSCell nor SCell of the SCG can transmit/receive data. If UL traffics related to the SCG arrives at the UE during the SCG suspension, the MN and SN may not aware of it. In this case, the UE may decide to resume or activate the suspended SCG. The resumption of the suspended SCG may be referred to as “SCG resumption” or “SCG activation” herein. Therefore, an efficient and robust SCG resumption mechanism should be specified. This efficient and robust SCG resumption can be applied to a variety of MR-DC deployments, including but not limited to the EN-DC, NGEN-DC, NR-DC deployments.

According to example embodiments of the present disclosure, there is provided a solution for SCG resumption. In this solution, if uplink transmission is to be performed with the SN, the terminal device may initiate the SCG resumption. In some embodiments, the terminal device may request to the MN for the SCG resumption. In some embodiments, the terminal device may request to the SN for the SCG resumption directly. Some example embodiments of the present disclosure will be described in detail below.

Example Process of Requesting to MN for SCG Resumption

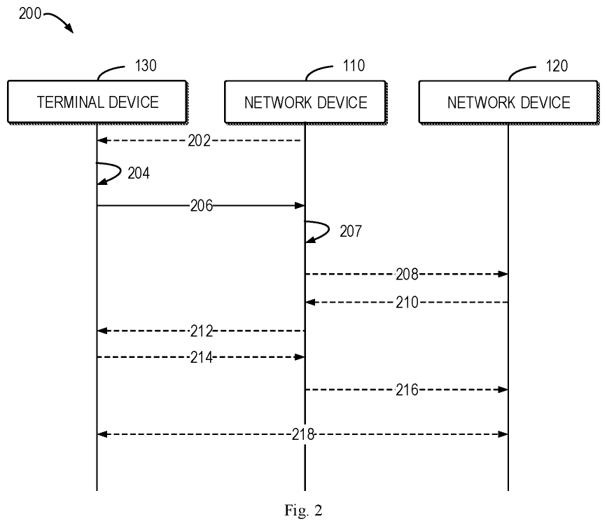

The SCG resumption may be triggered or initiated by the terminal device 130. FIG. 2 is a signaling chart illustrating process 200 of requesting to the MN for SCG resumption according to some embodiments of the present disclosure. For the purpose of discussion, the process 200 will be described with reference to FIG. 1. The process 200 may involve the terminal device 130, the network device 110 and the network device 120. In the process 200 of FIG. 2, the terminal device 120 requests to the network device 110 acting as the MN for the SCG resumption.

As a precondition, the SCG 160 of the network device 120 is suspended or deactivated. As shown in FIG. 2, in some embodiments, the network device 110 may transmit 202 to the terminal device 130 an indication to suspend the SCG 160 of the network device 120. Such an indication may be referred to as a SCG suspension indication. As an example, the SCG suspension indication may be an RRCReconfiguration message. In some embodiments, instead of the terminal device 110, the network device 120 may transmit the SCG suspension indication to the terminal device 130. The scope of the present disclosure is not limited in this regard.

The terminal device 120 determines 204 that UL transmission is to be performed with the network device 120. The UL transmission would be performed on one or more cells of the SCG 160. This case may be referred to as UL data arrival.

To enable the UL transmission, the terminal device 130 initiates a procedure for the SCG resumption with the network device 110. The terminal device 130 transmits 206 to the network device 110 a request to activate the SCG 160 of the network device 120. The request may be also referred to as “SCG activation request”. The SCG activation request comprises characteristic information concerning the UL transmission to be performed. The characteristic information may assist the network device 110 in determining how to handle the UL transmission and/or whether to respond to the SCG activation request.

In some embodiments, the characteristic information may comprise a cause triggering the UL transmission, which may be referred to as “SCG resumption cause”. For example, the SCG resumption cause may include, but not limited to, mobile originated video call (mo-VideoCall), mobile originated data (mo-Data), mobile originated voice call (mo-VoiceCall) and mobile originated signaling (mo-signaling).

Alternatively, or in addition, the characteristic information may comprise an identification (ID) of a data session associated with the UL transmission to be performed. The ID of the data session may assist the network device 110 in determining whether to relocate the data session. For example, the characteristic information may comprise a protocol data unit (PDU) session ID of the UL transmission.

The terminal device 130 may transmit 206 the SCG activation request using a signaling radio bear 1 (SRB1) between the network device 110 and the terminal device 120. The SCG activation request may be an RRC message, for example, a UEAsstianceInformation message. Other messages, for example, messages specific to the resumption request, are also possible.

In some embodiments, to avoid frequent transmission of the SCG activation request, a timer represented by “T3xx-1” may be introduced for the SCG resumption. The terminal device 130 may transmit the SCG activation request only when the timer T3xx-1 is not running. For example, the terminal device 130 may determine whether the timer T3xx-1 is running. If the timer T3xx-1 is not running, the terminal device 130 may transmit 206 the SCG activation request to the network device 110. Upon transmitting the SCG activation request, the terminal device 130 may start the timer T3xx-1.

In some embodiments, an upper value “t3xx-1” for the timer T3xx-1 may be provided to the terminal device 130 along with the indication to suspend the SCG 160, for example, the SCG suspension indication transmitted 202 by the network device 110. For example, in the embodiments where the SCG suspension indication is included in the RRC message, the RRC message may further comprise an IE indicating the upper value t3xx-1. In some other embodiments, the upper value t3xx-1 may be provided to the terminal device 130 in a dedicated RRC message.

If a procedure for connection re-establishment/RRC resume is initiated, the terminal device 130 may stop the timer T3xx-1. Alternatively, or in addition, if an RRC message indicating release of SCG configuration is received, the terminal device 130 may stop the timer T3xx-1.

The following Table 1 shows some attributes of the timer T3xx-1, which can be summarized from the above description. A starting condition for the timer T3xx-1 is transmission of the SCG activation request. A stopping condition for the timer T3xx-1 is initiation of the connection re-establishment/resume procedures and/or reception of an RRC message indicating the release of SCG configuration.

TABLE 1
Attributes of timer T3xx-1

| timer | Start | stop | at expiry |
|---|---|---|---|
| T3xx-1 | Upon transmitting | Upon initiation of the | No action |
| | the SCG activation | connection | |
| | request | re-establishment/resume | |
| | | procedures; | |
| | | and/or upon reception of | |
| | | an RRC message | |
| | | indicating the release of | |
| | | SCG configuration | |

Continuing with the process 200, after receiving the SCG activation request from the terminal device 130, the network device 110 determines 207 whether and when to activate the SCG 160. For example, the network device 110 may determine, from the SCG activation request, the characteristic information concerning the UL transmission and determine how to handle the UL transmission based on the characteristic information.

In some embodiments, the network device 110 may not respond to the SCG activation request. In some embodiments, the network device 110 may determine not to activate the SCG 160 and determine to handle the UL transmission itself. In such embodiments, the network device 110 may communicate with the CN 140 to relocate the data session associated with the UL transmission from the network device 120 to the network device 110. For example, the network device 110 may transmit the PDU session ID of the UL transmission to the CN 140. The CN 140 may relocate the PDU session to the network device 110.

In some embodiments, the network device 110 may determine to activate the SCG 160 of the network device 120. As an example without any limitation as to the scope of the present disclosure, FIG. 2 shows example actions for activating the SCG 160. As shown in FIG. 2, in such embodiments, the network device 110 may transmit 208 to the network device 120 a request to resume or activate the SCG 160 of the network device 120. Upon receiving the request, the network device 120 transmits 210 to the network device 110 a response to the request.

The network device 110 transmits 212 to the terminal device 130 a message to indicate the SCG resumption. This message may be referred to as a SCG resumption message. Upon receiving the SCG resumption message, the terminal device 130 may transmit 214 a response to the network device 110. As an example, the SCG resumption message may be an RRCReconfiguration message and the response may be an RRCReconfigurationComplete message. Other messages, for example, messages specific to the SCG resumption, are also possible.

Upon receiving the response from the terminal device 130, the network device 110 may transmit 216 to the network device 120 a message to notify the SCG resumption. As an example, this message may be a SgNBReconfigurationComplete message.

Upon receiving the SCG resumption message from the network device 110, a random access procedure may be performed 218 between the terminal device 130 and the network device 120.

In the above example embodiments, the terminal device 130 requests to the MN for the SCG resumption and whether to activate the SCG is determined by the MN. The characteristic information concerning the UL information may assist the MN in determining whether to resume the SCG, whether to request the core network to relocate the data session associated with the UL transmission. In some embodiments, the timer T3xx-1 may be introduced to avoid frequent transmission of the SCG activation request.

Example Processes of Requesting to SN for SCG Resumption

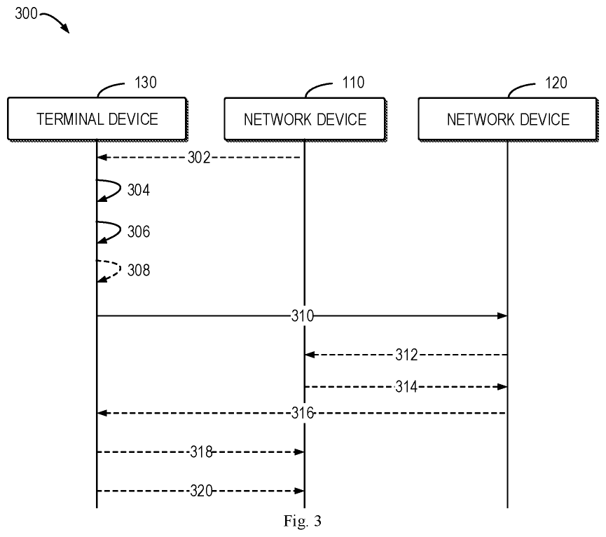

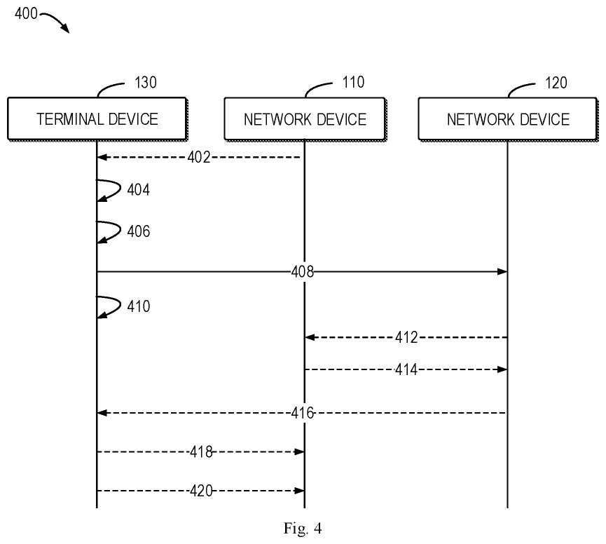

The SCG resumption may be triggered or initiated by the terminal device 130. In some embodiments, the terminal device 130 may request to the SN for SCG resumption. Some example processes are now described in detail with reference to FIGS. 3 and 4.

Example Process without Dedicated Signaling

FIG. 3 is a signaling chart illustrating process 300 of requesting to the SN for SCG resumption according to some embodiments of the present disclosure. For the purpose of discussion, the process 300 will be described with reference to FIG. 1. The process 300 may involve the terminal device 130, the network device 110 and the network device 120. In the process 300 of FIG. 3, the terminal device 120 requests to the network device 120 acting as the SN for the SCG resumption.

As a precondition, the SCG 160 of the network device 120 is suspended or deactivated. As shown in FIG. 3, in some embodiments, the network device 110 may transmit 302 to the terminal device 130 an indication to suspend the SCG 160 of the network device 120. Such an indication may be referred to as a SCG suspension indication. As an example, the SCG suspension indication may be an RRCReconfiguration message. In some embodiments, instead of the network device 110, the network device 120 may transmit the SCG suspension indication to the terminal device 130. The scope of the present disclosure is not limited in this regard.

The terminal device 120 determines 304 that UL transmission is to be performed with the network device 120. The UL transmission would be performed on one or more cells of the SCG 160.

To enable the UL transmission, the terminal device 130 initiates 306 a procedure for the SCG resumption with the network device 120. This procedure may be referred to as “SCG resumption procedure” or “SCG resumption procedure with the SN” herein. During the SCG resumption procedure, the terminal device 130 transmits 310 a random access request to the network device 110 to activate the SCG 160 of the network device 120. In the example process 300, no dedicated signaling is used to activate the SCG 160. Instead, the random access request may act as a request to activate the SCG 160, i.e., a SCG resumption request.

As mentioned above, in the SCG suspension, neither PSCell 160-1 nor SCell 160-2 of the SCG 160 can transmit/receive data. In order to transmit the random access request, the terminal device 130 may at least enable transmission on the PSCell 160-1 of the SCG 160.

In some embodiments, upon initiating the SCG resumption procedure, the terminal device 130 may resume transmission on the SCG 160, including transmission of data and signaling. For example, the terminal device 130 may resume SCG transmission for all SRBs and data radio bears (DRBs). Additionally, an upper layer (for example, the RRC layer) may indicate a lower layer (for example, the medium access control, MAC layer) to resume the SCG 160. A random access procedure on the PSCell 160-1 may thus be triggered by the MAC layer. As such, the random access request may be transmitted 310 to the network device 120. In the following, such embodiments may be referred to as “the embodiments where the SCG transmission is resumed” for the purpose of discussion without any limitation.

In some embodiments, upon initiating the SCG resumption procedure, the terminal device 130 may only resume transmission on the PSCell 160-1. The resumption of the transmission on the PSCell 160-1 may depend on the specific modeling of the SCG suspension. For example, if the PSCell 160-1 is deactivated in the SCG suspension, the terminal device 130 may activate the PSCell 160-1 to enable transmission on the PSCell 160-1. If the PSCell 160-1 is activated but the active BWP of the PSCell 160-1 is configured as a dormant BWP in the SCG suspension, the terminal device 130 may switch the active BWP of the PSCell 160-1 from the dormant BWP to a non-dormant BWP. In such embodiments, upon activation of the PSCell 160-1 or switch of the active BWP to the non-dormant BWP, the terminal device 130 may initiate a random access procedure on the PSCell 160-1 and transmit 310 the random access request to the network device 120. In the following, such embodiments may be referred to as “the embodiments where the PSCell transmission is resumed” for the purpose of discussion without any limitation.

The random access procedure on the PSCell 160-1 may be based on any suitable type random access. In some embodiments, the random access procedure on the PSCell 160-1 may be a four-step contention-based random access (CBRA) procedure. In these embodiments, the random access request transmitted 310 by the terminal device 130 may comprise a random access preamble in MSG1 and a Cell-Radio Network Temporary Identifier (C-RNTI) MAC control element (CE) in MSG3. In some embodiments, the random access procedure on the PSCell 160-1 may be a four-step contention-free random access (CFRA) procedure. In these embodiments, the random access request transmitted 310 by the terminal device 130 may comprise a random access preamble in MSG1.

In some embodiments, the random access procedure on the PSCell 160-1 may be a two-step CBRA procedure. In these embodiments, the random access request transmitted 310 by the terminal device 130 may comprise a random access preamble and a C-RNTI MAC CE in MSGA. In some embodiments, the random access procedure on the PSCell 160-1 may be a two-step CFRA procedure. In these embodiments, the random access request transmitted 310 by the terminal device 130 may comprise a random access preamble in MSGA.

In some embodiments, the random access procedure may be based on contention-free random access (CFRA). To enable the CFRA procedure, a dedicated random access resource may be reserved to the terminal device 130 for transmitting the SCG resumption request.

In some embodiments, the dedicated random access resource for CFRA may be indicated to the terminal device 130 along with the indication to suspend the SCG 160, for example the SCG suspension indication transmitted 302 by the network device 110. In some embodiments, the dedicated random access resource may be indicated in configuration for uplink BWP of the PSCell 160-1. For example, the dedicated random access resource may be indicated in the configuration for the active BWP and/or initial BWP of the PSCell 160-1.

In some embodiments, a timer represented by “T3xx-2(1)” may be introduced to monitor a response from the network device 120. The terminal device 130 may start 308 the timer T3xx-2(1) upon initiating the SCG resumption procedure.

In some embodiments, an upper value “t3xx-2(1)” for the timer T3xx-2(1) may be provided to the terminal device 130 along with the indication to suspend the SCG 160, for example the SCG suspension indication transmitted 302 by the network device 110. For example, in the embodiments where the SCG suspension indication is included in the RRC message, the RRC message may further comprise an IE indicating the upper value t3xx-2(1). In some other embodiments, the upper value t3xx-2(1) may be provided to the terminal device 130 in a dedicated RRC message.

Continuing with the process 300, the network device 120 receives from the terminal device 130 the random access request acting as the SCG resumption request. In some embodiments, the network device 120 may determine whether to activate the SCG 160 itself.

In some embodiments, the network device 120 may transmit a message to the network device 110 to confirm the SCG resumption request. For example, as shown in FIG. 3, the network device 120 may transmit 312 to the network device 110 a requirement to resume the SCG 160. This requirement may be also referred to as a “SCG resumption requirement”. Upon receiving the SCG resumption requirement, the network device 110 may transmit 314 to the network device 120 a confirmation to the SCG resumption requirement, which may be referred to as a “SCG resumption confirmation”.

In some embodiments, the network device 110 may configure the network device 120 as to actions taken when receiving the SCG resumption request. In some scenarios, the network device 110 may configure the network device 120 to determine whether to activate the SCG 160 itself. In some scenarios, the network device 110 may configure the network device 120 to transmit the SCG resumption requirement to confirm the SCG resumption request.

If the network device 120 determines to activate the SCG 160 or the network device 110 indicates the network device 120 to activate the SCG 160, the network device 120 may transmit 316 to the terminal device 130 a response to the random access request. In the embodiments where the random access procedure is the four-step CBRA procedure, the response may be MSG4 for contention resolution. In the embodiments where the random access procedure is the four-step CFRA procedure, the response may be MSG2, i.e., the random access response. In the embodiments where the random access procedure is the two-step random access procedure, the response may be MSGB for contention resolution.

If the terminal device 130 receives the response to the random access request from the network device 120, the terminal device 130 may determine that the random access procedure is successful. In the embodiments where the SCG transmission is resumed and the timer T3xx-2(1) is started, upon successful random access, the terminal device 130 may stop the timer T3xx-2(1). The terminal device 130 may consider that the SCG 160 is resumed successfully.

In the embodiments where the PSCell transmission is resumed and the timer T3xx-2(1) is started, upon successful random access, the terminal device 130 may stop the timer T3xx-2(1). The terminal device 130 may further resume all the transmission on the SCG 160, including transmission of data and signaling. For example, the terminal device 130 may resume the SCG transmission for all SRBs and DRBs in addition to the SRB3, which has been resumed previously. Additionally, the RRC layer may indicate the MAC layer to resume the SCG 160. For example, the SCells of the SCG 160 may be activated. Alternatively, active BWPs of the SCells of the SCG 160 may be switched to non-dormant BWPs.

In the embodiments where the SCG transmission is resumed and no timer is introduced, if no response is received from the network device 120, the terminal device 130 may determine that the random access procedure fails and thus consider that the SCG resumption procedure with the SN fails. Accordingly, the terminal device 130 may suspend the SCG transmission for all SRBs and DRBs and reset a MAC entity for the SCG 160, which may be referred to as “SCG MAC entity”. In some embodiments, the terminal device 130 may transmit 318 to the network device 110 a message indicating a failure in resuming or activating the SCG 160. The failure in resuming or activating the SCG 160 may be referred to as “SCG resumption failure”. Alternatively, or in addition, the terminal device 130 may transmit 320 to the network device 110 a request to activate the SCG 160 of the network device 120. The request transmitted 320 to the network device 110 may be the SCG activation request as described with reference to FIG. 2 for example. As such, a process of requesting to the MN for the SCG resumption may be performed.

In the embodiments where the SCG transmission is resumed and the timer T3xx-2(1) is started, upon expiration of the timer T3xx-2(1), the terminal device 130 may consider that the SCG resumption procedure with the SN fails. Accordingly, the terminal device 130 may suspend the SCG transmission for all SRBs and DRBs and reset the SCG MAC entity. Additionally, the RRC layer may indicate the MAC layer to suspend the SCG 160. In some embodiments, the terminal device 130 may transmit 318 to the network device 110 a message indicating the SCG resumption failure. Alternatively, or in addition, the terminal device 130 may transmit 320 to the network device 110 a request to activate the SCG 160 of the network device 120. The request transmitted 320 to the network device 110 may be the SCG activation request as described with reference to FIG. 2 for example. As such, a process of requesting to the MN for the SCG resumption may be performed.

In the embodiments where the PSCell transmission is resumed and the timer T3xx-2(1) is started, upon expiration of the timer T3xx-2(1), the terminal device 130 may consider that the SCG resumption procedure with the SN fails. Accordingly, the terminal device 130 may reset the SCG MAC entity. Additionally, the terminal device 130 may deactivate the PSCell 160-1 or switch the active BWP of the PSCell 160-1 to a dormant BWP. In some embodiments, the terminal device 130 may transmit 318 to the network device 110 a message indicating the SCG resumption failure. Alternatively, or in addition, the terminal device 130 may transmit 320 to the network device 110 a request to activate the SCG 160 of the network device 120. The request transmitted 320 to the network device 110 may be the SCG activation request as described with reference to FIG. 2 for example. As such, a process of requesting to the MN for the SCG resumption may be performed.

The following Table 2 shows some attributes of the timer T3xx-2(1), which can be summarized from the above description. A starting condition for the timer T3xx-2(1) is initiation of the SCG resumption procedure with the SN. A stopping condition for the timer T3xx-2(1) is successful completion of the random access procedure on the PSCell. At expiry of the timer T3xx-2(1), the terminal device 130 may inform network about the SCG resumption failure by initiating a SCG failure procedure and/or may transmit to the MN a request to activate the SCG.

TABLE 2
Attributes of timer T3xx-2(1)

| timer | Start | stop | at expiry |
|---|---|---|---|
| T3xx-2(1) | Upon initiation of | Upon successful | Inform network about the |
| | the SCG | completion of the random | SCG resumption failure by |
| | resumption | access procedure on the | initiating a SCG failure |
| | procedure with the | PSCell | procedure; and/or transmit |
| | SN | | to the MN a request to |
| | | | activate the SCG |

In the above embodiments, the terminal device 130 directly requests to the SN for SCG resumption. Since there is no need of message transmission between the terminal device 130 and the MN, latency of the SCG resumption procedure can be reduced. Moreover, the random access request acts as the request to activate the SCG and thus no dedicate signaling (for example, a RRC message) is needed.

Example Process with Dedicated Signaling

FIG. 4 is a signaling chart illustrating process 400 of requesting to the SN for SCG resumption according to some embodiments of the present disclosure. For the purpose of discussion, the process 400 will be described with reference to FIG. 1. The process 400 may involve the terminal device 130, the network device 110 and the network device 120. In the process 400 of FIG. 4, the terminal device 120 requests to the network device 120 acting as the SN for the SCG resumption.

As a precondition, the SCG 160 of the network device 120 is suspended or deactivated. As shown in FIG. 4, in some embodiments, the network device 110 may transmit 402 to the terminal device 130 an indication to suspend the SCG 160 of the network device 120. Such an indication may be referred to as a SCG suspension indication. As an example, the SCG suspension indication may be an RRCReconfiguration message. In some embodiments, instead of the network device 110, the network device 120 may transmit the SCG suspension indication to the terminal device 130. The scope of the present disclosure is not limited in this regard.

The terminal device 120 determines 404 that UL transmission is to be performed with the network device 120. The UL transmission would be performed on one or more cells of the SCG 160.

To enable the UL transmission, the terminal device 130 initiates 406 a procedure for the SCG resumption. This procedure may be referred to as “SCG resumption procedure” or “SCG resumption procedure with the SN” herein. Upon initiating the SCG resumption procedure, the terminal device 130 may resume an SRB on the SCG 160. For example, the terminal device 130 may resume the SRB3.

As mentioned above, in the SCG suspension, neither PSCell 160-1 nor SCell 160-2 of the SCG 160 can transmit/receive data. Therefore, upon initiating the SCG resumption procedure, the terminal device 130 may enable transmission on the PSCell 160-1 of the SCG 160. The resumption of the transmission on the PSCell 160-1 may depend on the specific modeling of the SCG suspension. For example, if the PSCell 160-1 is deactivated in the SCG suspension, the terminal device 130 may activate the PSCell 160-1 to enable transmission on the PSCell 160-1. If the PSCell 160-1 is activated but the active BWP of the PSCell 160-1 is configured as a dormant BWP in the SCG suspension, the terminal device 130 may switch the active BWP of the PSCell 160-1 from the dormant BWP to a non-dormant BWP.

Next, the terminal device 130 transmits 408 to the network device 120 a request to activate the SCG 160, i.e., the SCG resumption request. In the example process 400, the SCG resumption request transmitted 408 to the network device 120 is a dedicated signaling used to activate the SCG 160. The SCG resumption request may comprise characteristic information concerning the UL transmission to be performed. The characteristic information may assist the network device 120 in determining how to handle the SCG resumption request.

In some embodiments, the characteristic information may comprise a cause triggering the UL transmission, which may be referred to as “SCG resumption cause”. For example, the SCG resumption cause may include, but not limited to, mobile originated video call (mo-VideoCall), mobile originated data (mo-Data), mobile originated voice call (mo-VoiceCall) and mobile originated signaling (mo-signaling).

Alternatively, or in addition, the characteristic information may comprise an identification (ID) of a data session associated with the UL transmission to be performed. The ID of the data session may assist the network device 120 in determining whether to relocate the data session. For example, the characteristic information may comprise a protocol data unit (PDU) session ID of the UL transmission.

The terminal device 130 may transmit the SCG resumption request using the SRB3. The SCG resumption request may be an RRC message. For example, a SCGResumeRequest message may be defined for the SCG resumption procedure. Other RRC messages defined for other purposes, for example, the UEAssistanceInformation message, are also possible.

Although not shown in FIG. 4, it is to be understood that in order to transmit the SCG resumption request, a random access procedure on the PSCell 160-1 may be initiated by the terminal device 130. For example, the random access procedure may be triggered by the MAC layer due to arrival of the SCGResumeRequest message.

In some embodiments, the random access procedure on the PSCell 160-1 maybe the four-step CBRA procedure. In these embodiments, the terminal device 130 may transmit 408 the SCG resumption request in MSG3. Alternatively, or in addition, the terminal device 130 may transmit 408 the SCG resumption request using UL grant provided in MSG4. In some embodiments, the random access procedure on the PSCell 160-1 may be the four-step CFRA procedure. In these embodiments, the terminal device 130 may transmit 408 the SCG resumption request using UL grant provided by the network device 120.

In some embodiments, the random access procedure on the PSCell 160-1 may the two-step random access procedure. In these embodiments, the terminal device 130 may transmit 408 the SCG resumption request in MSGA. Alternatively, or in addition, the terminal device 130 may transmit 408 the SCG resumption request using UL grant provided in MSGB.

In some embodiments, the random access procedure may be based on the CFRA. The dedicated random access resource for CFRA may be indicated to the terminal device 130 along with the indication to suspend the SCG 160, for example the SCG suspension indication transmitted 402 by the network device 110. In some embodiments, the dedicated random access resource may be indicated in configuration for uplink BWP of the PSCell 160-1. For example, the dedicated random access resource may be indicated in the configuration for the active BWP and/or initial BWP of the PSCell 160-1.

A timer represented by “T3xx-2(2)” may be introduced to monitor a response from the network device 120. The terminal device 130 starts 410 the timer T3xx-2(2) upon transmitting the SCG resumption request.

In some embodiments, an upper value “t3xx-2(2)” for the timer T3xx-2(2) may be provided to the terminal device 130 along with the indication to suspend the SCG 160, for example the SCG suspension indication transmitted 402 by the network device 110. For example, in the embodiments where the SCG suspension indication is included in the RRC message, the RRC message may further comprise an IE indicating the upper value t3xx-2(2). In some other embodiments, the upper value t3xx-2(2) may be provided to the terminal device 130 in a dedicated RRC message.

Continuing with the process 400, the network device 120 receives from the terminal device 130 the SCG resumption request. In some embodiments, the network device 120 may determine whether to activate the SCG 160 itself.

In some embodiments, the network device 120 may transmit a message to the network device 110 to confirm the SCG resumption request. For example, as shown in FIG. 4, the network device 120 may transmit 412 to the network device 110 a SCG resumption requirement. The network device 120 may forward the characteristic information to the network device 110. For example, the characteristic information may be included in the SCG resumption requirement. The characteristic information may assist the network device 110 in determining how to handle the UL transmission and/or whether to activate the SCG 160. Upon receiving the SCG resumption requirement, the network device 110 may transmit 414 to the network device 120 a SCG resumption confirmation.

In some embodiments, the network device 110 may configure the network device 120 as to actions taken when receiving the SCG resumption request. In some scenarios, the network device 110 may configure the network device 120 to determine whether to activate the SCG 160 itself. In some scenarios, the network device 110 may configure the network device 120 to transmit the SCG resumption requirement to confirm the SCG resumption request.

After the network device 120 determines whether to activate the SCG 160 or not, the network device 120 transmits 416 to the terminal device 130 a response, which may be referred to as “SCG resumption response”. The SCG resumption response may be an RRC message. For example, the SCG resumption response may be the SCGResumeRequest message defined for the SCG resumption procedure, or the UEAssistanceInformationmessage. The response may indicate that activating the SCG 160 is allowed or activating the SCG 160 is rejected.

If the response indicates that activating the SCG 160 is allowed, the terminal device 130 may determine that the SCG resumption is successful. Accordingly, the terminal device 130 may stop the timer T3xx-2(2). The terminal device 130 may further resume all the transmission on the SCG 160, including transmission of data and signaling. For example, the terminal device 130 may resume the SCG transmission for all SRBs and DRBs in addition to the SRB3, which has been resumed previously. Additionally, the RRC layer may indicate the MAC layer to resume the SCG 160. For example, the SCells of the SCG 160 may be activated. Alternatively, initial BWPs or active BWPs of the SCells of the SCG 160 may be switched to non-dormant BWPs.

If the response indicates that activating the SCG 160 is rejected, the terminal device 130 may stop the timer T3xx-2(2) and suspend the SRB3. Additionally, a high layer (e.g., the RRC layer) may indicate a low layer (e.g., the MAC layer) to deactivate the PSCell 160-1 or switch the active/initial BWP of the PSCell 160-1 to a dormant BWP.

If the response indicates that activating the SCG 160 is rejected, the response may further comprise an upper value for a timer T3xx-3. Upon receiving the response, the terminal device 130 may start the timer T3xx-3. The upper value t3xx-3 for the timer T3xx-3 may be considered as wait time. If the timer T3xx-3 is running, the terminal device 130 shall not transmit the SCG resumption request to the terminal device 120. In such embodiments, the terminal device 120 may determine whether the timer T3xx-3 is running. If the timer T3xx-3 is not running, the terminal device 130 may transmit 408 the SCG resumption request. In some embodiments, the timer T3xx-3 may be the same timer as the timer T3xx-1. Alternatively, the timer T3xx-3 may be a timer different from the timer T3xx-1.

In some embodiments, if the response indicates that activating the SCG 160 is rejected, the response may further comprise reconfiguration information of the MCG 150 of the network device 110. The terminal device 130 may reconfigure the MCG 150 based on the reconfiguration information. For example, the response may include an embedded RRCReconfiguration message for the MCG 150. The terminal device 130 may then apply the configuration of the MCG 150 as indicated in the embedded RRCReconfiguration message.

If the timer T3xx-2(2) expires, the terminal device 130 may consider that the SCG resumption procedure with the SN fails. Accordingly, upon the expiration of the timer T3xx-2(2), the terminal device 130 may suspend the SRB3 and reset the SCG MAC entity. Additionally, the terminal device 130 may deactivate the PSCell 160-1 or switch the active BWP of the PSCell 160-1 to a dormant BWP. In some embodiments, the terminal device 130 may transmit 418 to the network device 110 a message indicating the SCG resumption failure. Alternatively, or in addition, the terminal device 130 may transmit 420 to the network device 110 a request to activate the SCG 160 of the network device 120. The request transmitted 420 to the network device 110 may be the SCG activation request as described with reference to FIG. 2 for example. As such, a process of requesting to the MN for the SCG resumption may be performed.

The following Table 3 shows some attributes of the timer T3xx-2(2), which can be summarized from the above description. A starting condition for the timer T3xx-2(2) is transmission of the SCG resumption request to the SN. A stopping condition for the timer T3xx-2(2) is reception of a response indicating that the SCG resumption is allowed or a response indicating that the SCG resumption is rejected. At expiry of the timer T3xx-2(2), the terminal device 130 may inform network about the SCG resumption failure by initiating a SCG failure procedure and/or may transmit to the MN a request to activate the SCG.

TABLE 3
Attributes of timer T3xx-2(2)

| timer | Start | stop | at expiry |
|---|---|---|---|
| T3xx-2(2) | Upon transmission | Upon reception of a | Inform network about the |
| | of the SCG | response indicating that | SCG resumption failure by |
| | resumption | the SCG resumption is | initiating a SCG failure |
| | request to the SN | allowed or a response | procedure; and/or transmit |
| | | indicating that the SCG | to the MN a request to |
| | | resumption is rejected | activate the SCG |

The following Table 4 shows some attributes of the timer T3xx-3, which can be summarized from the above description. A starting condition for the timer T3xx-3 is reception of a response indicating that the SCG resumption is rejected. A stopping condition for the timer T3xx-3 is SCG resumption and/or reception of an RRC message indicating the release of SCG configuration.

TABLE 4
Attributes of timer T3xx-3

| timer | Start | stop | at expiry |
|---|---|---|---|
| T3xx-3 | Upon reception of | Upon SCG resumption; | No action |
| | a response | and/or upon reception of | |
| | indicating that the | an RRC message | |
| | SCG resumption is | indicating the release of | |
| | rejected | SCG configuration | |

In the above embodiments, the terminal device 130 directly requests to the SN for SCG resumption. Since there is no need of message transmission between the terminal device 130 and the MN, latency of the SCG resumption procedure can be reduced. Moreover, a dedicate signaling (for example, an RRC message) is used for the SCG resumption request. In this way, the SCG resumption request may include additional information, for example, the characteristic information concerning the UL transmission. The additional information may assist the SN in determining how to handle the SCG resumption request.

Example Method

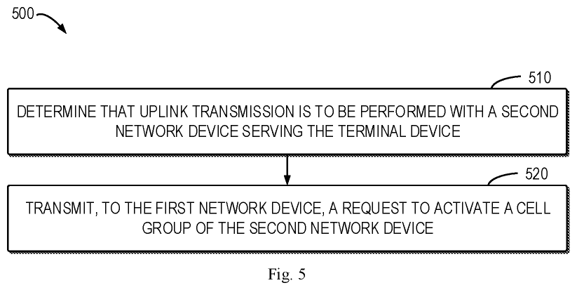

FIG. 5 illustrates a flowchart of an example method 500 according to some embodiments of the present disclosure. The method 500 can be implemented at the terminal device 130 as shown in FIG. 1. It is to be understood that the method 500 may include additional blocks not shown and/or may omit some blocks as shown, and the scope of the present disclosure is not limited in this regard. For the purpose of discussion, the method 500 will be described from the perspective of the terminal device 130 with reference to FIG. 1.

At block 510, the terminal device 130 served by a first network device 110 determines that uplink transmission is to be performed with a second network device 120 serving the terminal device 130. The first network device 110 may be a master node serving the terminal device 130 and the second network device 120 may be a secondary node serving the terminal device 130. At block 520, the terminal device 130 transmits, to the first network device 110, a request to activate a cell group of the second network device 120. The request comprises characteristic information concerning the uplink transmission.

In some embodiments, the characteristic information comprises at least one of: a cause triggering the uplink transmission, or an identification of a data session associated with the uplink transmission.

In some embodiments, transmitting the request comprises: determining whether a timer for activation of the cell group is running; and in accordance with a determination that the timer is not running, transmitting the request.

In some embodiments, the method 500 further comprises: in response to transmitting the request, starting the timer.

In some embodiments, the method 500 further comprises: receiving, from the first network device 110 or the second network device 120, an upper value for the timer along with an indication to deactivate the cell group.

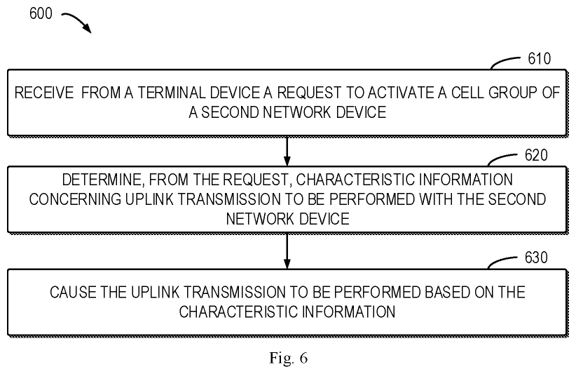

FIG. 6 illustrates a flowchart of an example method 600 according to some embodiments of the present disclosure. The method 600 can be implemented at the first network device 110 as shown in FIG. 1. It is to be understood that the method 600 may include additional blocks not shown and/or may omit some blocks as shown, and the scope of the present disclosure is not limited in this regard. For the purpose of discussion, the method 600 will be described from the perspective of the first network device 110 with reference to FIG. 1.

At block 610, the first network device 110 receives from a terminal device 130, a request to activate a cell group of a second network device 120. The terminal device 130 is served by the first network device 110 and the second network device 120. At block 620, the first network device 110 determines, from the request, characteristic information concerning uplink transmission to be performed with the second network device 120. At block 630, the first network device 110 causes the uplink transmission to be performed based on the characteristic information.

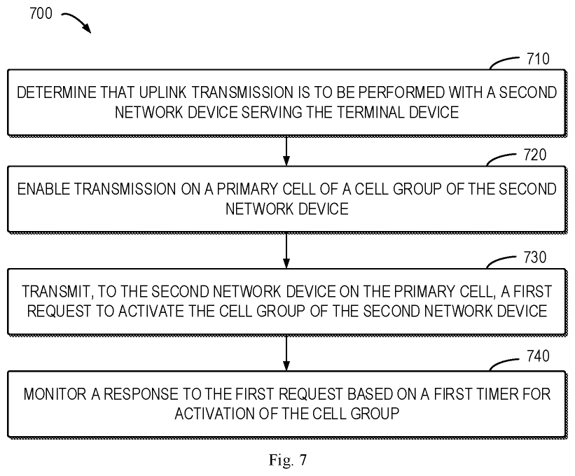

FIG. 7 illustrates a flowchart of an example method 700 according to some embodiments of the present disclosure. The method 700 can be implemented at the terminal device 130 as shown in FIG. 1. It is to be understood that the method 700 may include additional blocks not shown and/or may omit some blocks as shown, and the scope of the present disclosure is not limited in this regard. For the purpose of discussion, the method 700 will be described from the perspective of the terminal device 130 with reference to FIG. 1.

At block 710, the terminal device 130 served by a first network device 110 determines that uplink transmission is to be performed with a second network device 120 serving the terminal device 130. At block 720, the terminal device 130 enables transmission on a primary cell of a cell group of the second network device 120. At block 730, the terminal device 130 transmits, to the second network device 120 on the primary cell, a first request to activate the cell group of the second network device 120. At block 740, the terminal device 130 monitors a response to the first request based on a first timer for activation of the cell group.

In some embodiments, the method 700 further comprises: in accordance with a determination that the first timer expires, transmitting to the first network device 110 at least one of: a message indicating a failure in activating the cell group of the second network device 120, or a second request to activate the cell group of the second network device 120.

In some embodiments, the first request comprises a random access request for a random access procedure, and the method further comprises: in accordance with a determination that the random access procedure is successful, stopping the first timer.

In some embodiments, the first request comprises a radio resource control (RRC) message, and transmitting the first request comprises: resuming a signaling radio bearer on the cell group; and transmitting the RRC message by using the signaling radio bearer.

In some embodiments, the method 700 further comprises: receiving a first response to the first request from the second network device 120, the first response indicating that activating the cell group is allowed; and in response to receiving the first response, stopping the first timer; resuming a further signaling radio bearer on the cell group and data radio bearers on the cell group; and enabling transmission on one or more secondary cell of the cell group.

In some embodiments, the method 700 further comprises: receiving a second response to the first request from the second network device 120, the second response indicating that activating the cell group is rejected; and in response to receiving the second response, stopping the first timer; suspending the signaling radio bearer on the cell group; and starting a second timer with an upper value indicated in the second response.

In some embodiments, transmitting the RRC message comprises: determining whether the second timer is running; and in accordance with a determination that the second timer is not running, transmitting the RRC message.

In some embodiments, the method 700 further comprises: in accordance with a determination that the second response comprises reconfiguration information of a further cell group of the first network device 110, reconfigure the further cell group based on the reconfiguration information.

In some embodiments, the RRC message comprises characteristic information concerning the uplink transmission.

In some embodiments, enabling the transmission on the primary cell of the cell group comprises: enabling the transmission on the primary cell of the cell group by switching the primary cell from a dormant bandwidth part (BWP) to a non-dormant BWP, or enabling the transmission on the primary cell of the cell group by activating the primary cell.

In some embodiments, transmitting the first request comprises: determining, from an indication to deactivate the cell group, a resource for a random access procedure, the indication received from the first network device 110 or the second network device 120; and transmitting the first request by initiating the random access procedure on the primary cell using the determined resource.

In some embodiments, there is provided a method which can be implemented at a network device, for example, the network device 110 as shown in FIG. 1. The method may comprise acts performed by the network device 110 as described with reference to FIGS. 2-4.

In some embodiments, there is provided a method which can be implemented at a network device, for example, the network device 120 as shown in FIG. 1. The method may comprise acts performed by the network device 120 as described with reference to FIGS. 2-4.

Example Device

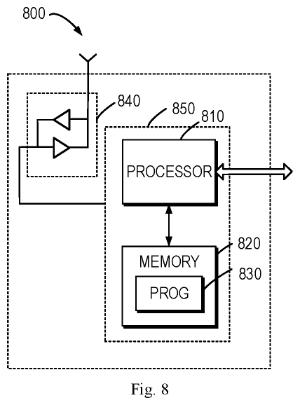

FIG. 8 is a simplified block diagram of a device 800 that is suitable for implementing embodiments of the present disclosure. The device 800 can be considered as a further example implementation of the terminal device 130, the network device 120, or the network device 110 as shown in FIG. 1. Accordingly, the device 800 can be implemented at or as at least a part of the terminal device 130, the network device 120, or the network device 110.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIGS. 2-7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 810 may form processing means 850 adapted to implement various embodiments of the present disclosure.

The memory 810 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 810 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication comprising:
determining, at a terminal device served by a first network device, that uplink transmission is to be performed with a second network device serving the terminal device; and
transmitting, to the first network device, a request to activate a cell group of the second network device, the request comprising characteristic information concerning the uplink transmission.

2. The method of claim 1, wherein the characteristic information comprises at least one of:
a cause triggering the uplink transmission, or
an identification of a data session associated with the uplink transmission.

3. The method of claim 1, wherein transmitting the request comprises:
determining whether a timer for activation of the cell group is running; and
in accordance with a determination that the timer is not running, transmitting the request.

4. The method of claim 3, further comprising:
in response to transmitting the request, starting the timer.

5. The method of claim 3, further comprising:
receiving, from the first network device or the second network device, an upper value for the timer along with an indication to deactivate the cell group.

6. A method of communication comprising:
receiving, at a first network device from a terminal device, a request to activate a cell group of a second network device, the terminal device served by the first network device and the second network device;
determining, from the request, characteristic information concerning uplink transmission to be performed with the second network device; and
causing the uplink transmission to be performed based on the characteristic information.

7. A method of communication comprising:
determining, at a terminal device served by a first network device, that uplink transmission is to be performed with a second network device serving the terminal device;
enabling transmission on a primary cell of a cell group of the second network device;
transmitting, to the second network device on the primary cell, a first request to activate the cell group of the second network device; and
monitoring a response to the first request based on a first timer for activation of the cell group.

8. The method of claim 7, further comprising:
in accordance with a determination that the first timer expires, transmitting to the first network device at least one of:
a message indicating a failure in activating the cell group of the second network device, or
a second request to activate the cell group of the second network device.

9. The method of claim 7, wherein the first request comprises a random access request for a random access procedure, and the method further comprises:
in accordance with a determination that the random access procedure is successful, stopping the first timer.

10. The method of claim 7, wherein the first request comprises a radio resource control (RRC) message, and transmitting the first request comprises:
resuming a signaling radio bearer on the cell group; and
transmitting the RRC message by using the signaling radio bearer.

11. The method of claim 10, further comprises:
receiving a first response to the first request from the second network device, the first response indicating that activating the cell group is allowed; and
in response to receiving the first response,
stopping the first timer;
resuming a further signaling radio bearer on the cell group and data radio bearers on the cell group; and
enabling transmission on one or more secondary cell of the cell group.

12. The method of claim 10, further comprises:
receiving a second response to the first request from the second network device, the second response indicating that activating the cell group is rejected; and
in response to receiving the second response,
stopping the first timer;
suspending the signaling radio bearer on the cell group; and
starting a second timer with an upper value indicated in the second response.

13. The method of claim 12, wherein transmitting the RRC message comprises:
determining whether the second timer is running; and
in accordance with a determination that the second timer is not running, transmitting the RRC message.

14. The method of claim 11, further comprising:
in accordance with a determination that the second response comprises reconfiguration information of a further cell group of the first network device, reconfigure the further cell group based on the reconfiguration information.

15. The method of claim 10, wherein the RRC message comprises characteristic information concerning the uplink transmission.

16. The method of claim 7, wherein enabling the transmission on the primary cell of the cell group comprises:
enabling the transmission on the primary cell of the cell group by switching the primary cell from a dormant bandwidth part (BWP) to a non-dormant BWP, or
enabling the transmission on the primary cell of the cell group by activating the primary cell.

17. The method of claim 7, wherein transmitting the first request comprises:
determining, from an indication to deactivate the cell group, a resource for a random access procedure, the indication received from the first network device or the second network device; and
transmitting the first request by initiating the random access procedure on the primary cell using the determined resource.

18. A terminal device comprising:
a processor; and
a memory coupled to the processor and storing instructions thereon, the instructions, when executed by the processor, causing the terminal device to perform the method according to any of claims 1 to 5.

19. A network device comprising:
a processor; and
a memory coupled to the processor and storing instructions thereon, the instructions, when executed by the processor, causing the terminal device to perform the method according to claim 6.

20. A terminal device comprising:
a processor; and
a memory coupled to the processor and storing instructions thereon, the instructions, when executed by the processor, causing the terminal device to perform the method according to any of claims 7 to 17.

21. A computer readable medium having instructions stored thereon, the instructions, when executed on at least one processor, causing the at least one processor to perform the method according to any of claims 1 to 5.

22. A computer readable medium having instructions stored thereon, the instructions, when executed on at least one processor, causing the at least one processor to perform the method according to claim 6.

23. A computer readable medium having instructions stored thereon, the instructions, when executed on at least one processor, causing the at least one processor to perform the method according to any of claims 7 to 17.
